(19) United States
(12) Patent Application Publication
(10) Pub. No.: US 2023/0087470 A1
(43) Pub. Date: Mar. 23, 2023

(54) MEMORY SYSTEM AND CONTROL METHOD

(71) Applicant: KIOXIA CORPORATION, Tokyo (JP)

(72) Inventor: Ryoichi KATO, Yohama Kanagawa (JP)

(21) Appl. No.: 17/679,859

(22) Filed: Feb. 24, 2022

(30) Foreign Application Priority Data
Sep. 17, 2021 (JP) 2021-152308

(51) Int. Cl. G06F 3/06

(52) U.S. Cl. CPC G06F 3/064; G06F 3/0652; G06F 3/0608; G06F 3/0683

(57) ABSTRACT

According to one embodiment, a memory system includes a non-volatile memory having a plurality of blocks and a controller to execute a garbage collection process of moving valid data from first blocks in the plurality of blocks to second blocks in the plurality of blocks. After the garbage collection process, one or more free blocks are generated since the number of second blocks is fewer than the number of the first blocks. The controller selects the first blocks for the garbage collection process based on a reduction frequency of valid data in the blocks in the plurality of blocks.

### CROSS-REFERENCE TO RELATED APPLICATION

This application is based upon and claims the benefit of priority from Japanese Patent Application No. 2021-152308, filed Sep. 17, 2021, the entire contents of which are incorporated herein by reference.

### FIELD

Embodiments described herein relate generally to a memory system and a control method related to a memory system.

### BACKGROUND

In recent years, memory systems such as a solid-state drive (SSD) having a NAND flash memory (NAND memory) have become widely used. NAND memory is a non-volatile storage medium in which stored data in a storage area cannot be simply overwritten with new data written to the storage area, but rather the storage area must be erased before the next writing. For this reason, a SSD typically rewrites data by writing the data to a storage area different from the storage area in which original data was stored and listing the original data in the previous storage area as invalid. Therefore, in a memory system such as SSD, a process called garbage collection is required in order to reuse the storage area on the NAND memory in which the now-invalid data is stored. The garbage collection process or operation is also called compaction.

The SSD writes and reads data to and from the NAND memory in units called pages, but the SSD erases data in units called blocks including a plurality of the pages. The garbage collection selects a block containing many pages in which invalid data is stored (in other words, a block having a small amount of valid data) and then moves the valid data from N (where N is a natural number of 2 or more) total blocks to less than N total blocks to generate one or more free blocks.

The data stored in the NAND memory can be roughly classified into “cold data” for which rewriting is unlikely to occur and “hot data” for which rewriting is likely to occur. In other words, expected access frequency of the cold data is lower than the expected access frequency of the hot data. When only the cold data is stored in a block, the block is likely to be maintained at a high occupation ratio of the valid data. Therefore, if cold data can be collected and consolidated in fewer blocks, the occupation ratio of the valid data in the other blocks can be reduced as compared with the occupation ratio of the valid data in all blocks. In general, efficiency of the garbage collection is improved as the total amount of the valid data is decreased. The blocks formed by collecting the cold data (which are highly likely to be maintained at a high occupation ratio of the valid data) are less likely to be selected as a target for the garbage collection. On the other hand, the blocks (“hot blocks”) left after the consolidation of the cold data are more likely to be selected as the target for the garbage collection. Therefore, by consolidating cold data in fewer blocks, the efficiency of the garbage collection can be expected to be improved.

### BRIEF DESCRIPTION OF THE DRAWINGS

FIG. 1 is a diagram of a memory system according to an embodiment.

FIG. 2 is a diagram of a NAND memory die of a memory system of an embodiment.

FIG. 3 is a diagram of a superblock of a memory system of an embodiment.

FIG. 4 is a diagram illustrating a basic outline of a garbage collection.

FIGS. 5A and 5B relate to an example of a garbage collection based only on a small amount of valid data.

FIG. 6 illustrates an example of garbage collection in which cold data is consolidated.

FIGS. 7A and 7B are diagrams illustrating the garbage collection in a second mode in a memory system of an embodiment.

FIG. 8 is a flowchart of garbage collection in a second mode in a memory system of an embodiment.

### DETAILED DESCRIPTION

Embodiments provide a memory system that suitably performs garbage collection of blocks storing what is referred to as cold data.

In general, according to one embodiment, a memory system includes a non-volatile memory and a controller. The non-volatile memory has a plurality of blocks including first blocks with valid data therein and second blocks without valid data therein. The controller is configured to execute a garbage collection process in which valid data of first blocks is moved (rewritten) to second blocks. The number of second blocks is fewer than the number of the first blocks, thus the garbage collection process generates one or more free (available) blocks by a consolidation of valid data into fewer total blocks. The controller selects the first blocks for the garbage collection process based on a reduction frequency of valid data within blocks in the plurality of blocks.

Certain example embodiments will be described with reference to the drawings.

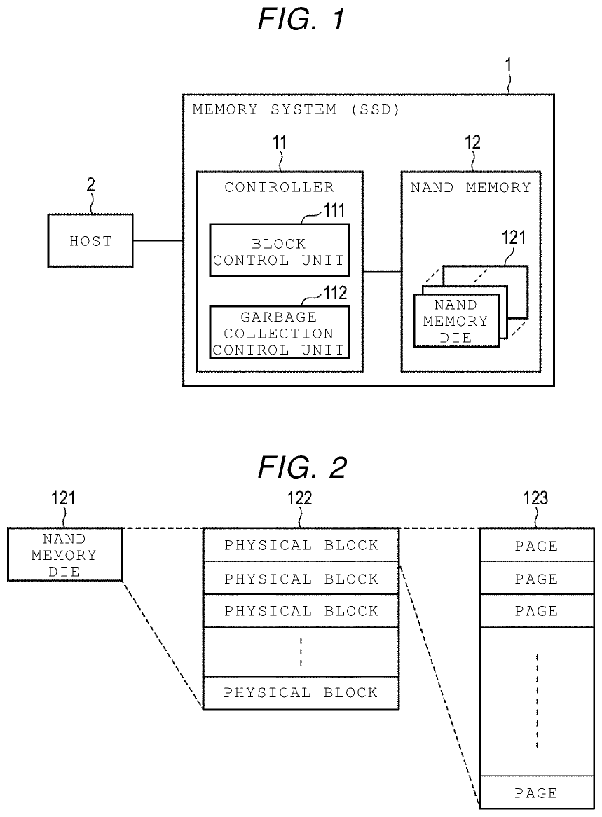

FIG. 1 is a diagram illustrating a configuration example of a memory system 1 of an embodiment. A memory system 1 implemented as an SSD will be described as one example. The memory system 1 is connectable to a host 2. FIG. 1 illustrates a configuration example of an information processing system including the memory system 1 and the host 2 connected to the memory system 1. The host 2 can be an information processing device such as a server or a personal computer.

The memory system 1 includes a controller 11 and a NAND flash memory 12 (NAND memory 12). The memory system 1 is connected to the host 2 via, for example, an interface conforming to a PCI Express™ (PCIe™) specification.

The controller 11 is a device that controls the NAND memory 12. The controller 11 controls a process of writing data to the NAND memory 12 and a process of reading data from the NAND memory 12 according to commands from the host 2. The controller 11 communicates with the host 2 by using a protocol conforming to, for example, an NVM Express™ (NVMe™) specification. The controller 11 can be configured as a semiconductor integrated circuit such as a System on a Chip (SoC).

The NAND memory 12 is a non-volatile storage medium in which data cannot be directly overwritten in a storage area in which data has already been written. The NAND memory 12 includes a plurality of NAND flash memory dies 121 (NAND memory dies 121). Each NAND memory die 121 can also be referred to as a NAND memory chip or the like. A NAND memory die 121 includes a memory cell array capable of non-volatilely storing data and a peripheral circuit for controlling the memory cell array. The memory cell array includes a plurality of physical blocks. The individual NAND memory dies 121 can operate independently of one another. A certain number of the NAND memory dies 121 may function as units for parallel operation.

The controller 11 has a block management unit 111 and a garbage collection control unit 112. The block management unit 111 and the garbage collection control unit 112 may be implemented as firmware (program) or as hardware such as an electronic circuit.

The block management unit 111 is a module that manages a logical block (hereinafter, referred to as a superblock) which is an extended management unit incorporating a certain number of physical blocks from among a plurality of physical blocks provided in the NAND memory 12. The certain number in this context is, for example, a number equal to the number of NAND memory dies 121 within a unit for parallel operation. The block management unit 111 manages information about each superblock as block information. The block management unit 111 also supplies an unused superblock(s) to the garbage collection control unit 112 as a write destination(s) during garbage collection.

A superblock as managed by the block management unit 111 will be described.

FIG. 2 is a diagram illustrating a configuration example of the NAND memory die 121. Each NAND memory die 121 includes the plurality of the physical blocks 122. Each of the physical blocks 122 includes a plurality of the pages 123. Data writing and reading to and from the NAND memory die 121 is executed in page units (one page 123 is a base or minimum unit).

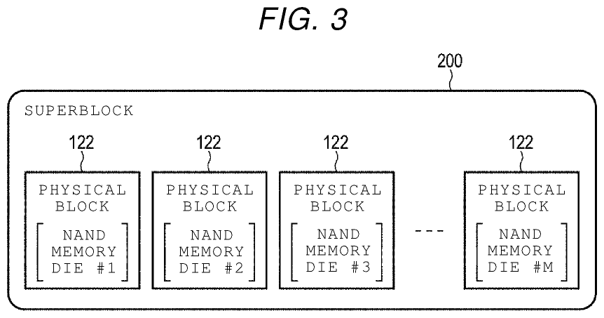

FIG. 3 is a diagram illustrating a configuration example of the superblock 200. In this example, a total of M (where M is a natural number of 2 or more) NAND memory dies 121 function as units of parallel operation will be described. The block management unit 111 selects a physical block 122 from each of the M NAND memory dies 121 and generates the superblock 200 including the selected M physical blocks 122. Since M NAND memory dies 121 can operate in parallel, writing data to the superblock 200 can be executed as M pages (one page, per physical block 122). In the memory system 1 of the present embodiment, data erasure is executed in units of the superblock 200 (that is, erasing is performed on a superblock 200 basis).

The garbage collection control unit 112 shown in FIG. 1 controls the garbage collection (GC) for reusing a page 123 in which invalid data is stored. As described above, the NAND memory 12 is a storage medium in which the data cannot be overwritten in the storage area in which data has already been written. That is, previously written data in a storage area must be erased from the storage area before new data may be written to the storage area. For example, rewriting or updating of data stored in a particular page 123 of a particular superblock 200 is executed by writing the new (updated) data to a different page 123 of a different superblock 200 and then invalidating the data stored in the particular page 123 of the particular superblock 200. Therefore, a situation may eventually occur in which one superblock 200 is filled (or substantially so) by pages 123 that only store invalid data. The garbage collection control unit 112 basically selects for garbage collection the superblocks 200 in which the level (amount) of valid data is low (small). The garbage collection control unit 112 moves (rewrites) the valid data from the selected superblocks 200 to other superblocks 200 in a manner that fewer superblocks 200 are occupied with any valid data. The superblocks 200 from which all valid data is removed are referred to as unused superblocks 200. An unused superblock 200 may also be referred to as a free block or the like.

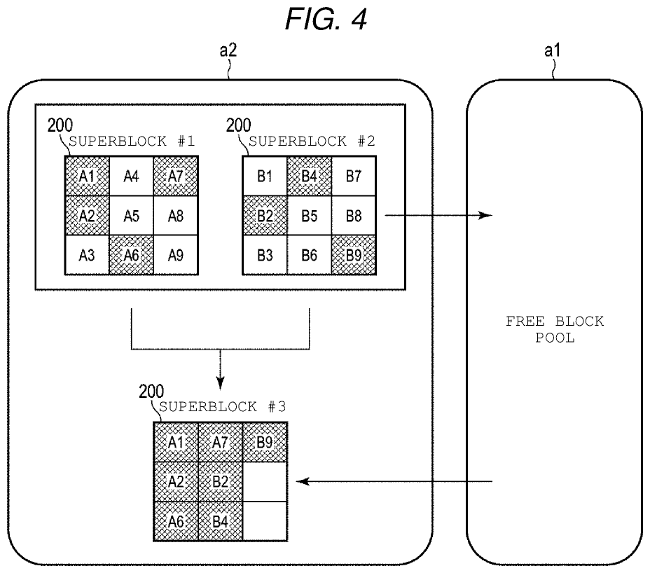

FIG. 4 is a diagram illustrating aspects related to a basic outline of a garbage collection process.

For brief description, each superblock 200 includes only nine total pages. The superblock 200 (#1) includes the pages A1 to A9. The superblock 200 (#2) includes the pages B1 to B9. In the figure, unhatched pages (A3 to A5, A8, A9, B1, B3, and B5 to B8) indicate pages that store invalid data. The hatched pages (A1, A2, A6, A7, B2, B4, and B9) indicate pages for storing valid data. The garbage collection control unit 112 first receives notification of the superblock 200 (#3), which is a free block, from the block management unit 111.

In FIG. 4, free blocks are stored in a free block pool a1 for the convenience. The superblocks 200 in the frame a2 are superblocks 200 that has been previously extracted from the free block pool a1 and are in a used state. The superblocks 200 in the used state are those in which data writing is in process and those in which data writing has been completed and at least some valid data is stored therein. Such a superblock 200 may be called an active block or the like.

The garbage collection control unit 112 copies the valid data in the superblocks 200 (#1, #2), that is, data stored in the pages A1, A2, A6, A7, B2, B4, and B9 to the superblock 200 (#3). The garbage collection control unit 112 then invalidates the previous valid data in the superblock 200 (#1, #2) and allows the superblocks 200 (#1, #2) to be treated as free blocks for subsequent reuse. By moving the valid data of the two superblocks 200 (#1, #2) to one superblock 200 (#3), a net increase of one free block is secured.

As described above, the block management unit 111 manages the block information about the superblocks 200. The block information includes the valid cluster rate. The valid cluster rate is a ratio of the pages 123 that store valid data to all the available pages 123 in the superblock 200. The superblock 200 having a low valid cluster rate is a superblock 200 having a small amount of the valid data. In standard garbage collection, the garbage collection control unit 112 primarily selects the superblocks 200 having a low valid cluster rate as the superblocks 200 to be the movement source.

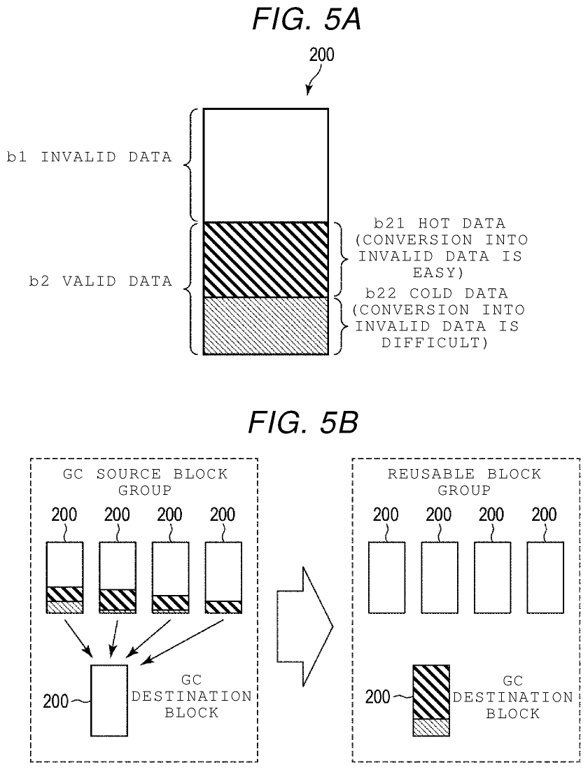

FIG. 5A illustrates additional details of data stored in a superblock 200. As illustrated in FIG. 5A, an active superblock 200 may include both invalid data b1 and valid data b2. The valid data b2 may include hot data b21 (that is, valid data that is likely to be converted into invalid data in a relatively short time frame) and cold data b22 (that is, valid data that is relatively unlikely to be converted into invalid data during the relatively short time frame). The data that is likely to be converted into the invalid data is data that has a high access frequency and is thus highly likely to be rewritten. The data that is less likely to be converted into the invalid data is data that has a relatively low access frequency and thus is less likely to be rewritten. In general, the memory system 1 cannot specifically know which portions of the valid data b2 are the hot data b21 and which are the cold data b22, but such may be estimated.

The superblocks 200 with valid data b2 therein are selected based only on the small amount of the valid data b2. FIG. 5B illustrates an example in which the four superblocks 200 are selected as movement source blocks (“GC source block group”) in the garbage collection in ascending order of amount of the valid data b2. The results of the garbage collection of the four selected superblocks 200 (“GC source block group”) show the hot data b21 and the cold data b22 are mixed in the destination superblock 200 (“GC destination block”). For this reason, the destination superblock 200 may be likely to be selected as a movement source block after the hot data b21 portion decreases with the passage of time. Then, re-movement of the cold data b22 occurs.

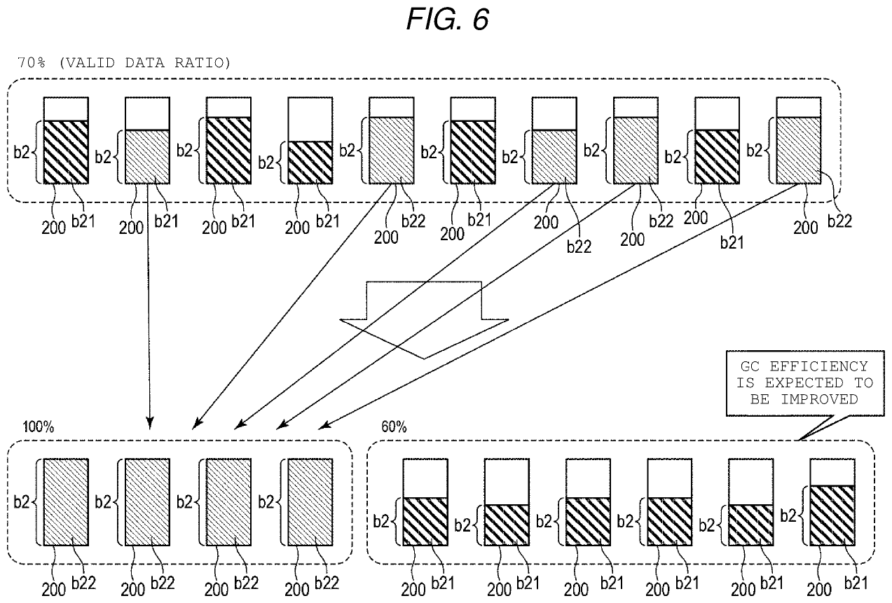

An example of garbage collection in which the cold data b22 are consolidate in single superblocks 200 will be described with reference to FIG. 6.

FIG. 6 illustrates, in an upper figure, a state in which the occupation ratio of the valid data b2 in all the superblocks 200 in the used state is 70%. All the superblocks 200 include either the data b21 (hot data) or the data b22 (cold data). FIG. 6 illustrates, in a lower left figure, a state in which the cold data b22 is consolidated in superblocks 200 without hot data b21 (or any invalid data b1). That is, none of the consolidated cold data b22 is invalid (valid data ratio is 100%), and no surplus area is left in any of the superblocks 200 in which the cold data b22 is collected.

After consolidating of the cold data b22, the hot data b21 remains in superblocks 200 from which the cold data b22 was collected. FIG. 6 illustrates, in a lower right figure, the state of the superblocks 200 in which the hot data b21 remains. The average occupation ratio of the valid data b2 in the superblocks 200 in which the hot data b21 remains is 60%, which is lower than the occupation ratio 70% of the valid data b2 in all the used superblocks 200 initially (before consolidation of cold data b21).

The efficiency of the garbage collection is improved as the valid data ratio is lowered. The superblocks 200 in which the cold data b22 is collected is likely to be maintained at a high occupation ratio of the valid data b2 since relatively few portions of the cold data b21 will be accessed or overwritten. Therefore, these “cold” superblocks 200 are less likely to be selected as the target of the garbage collection. On the other hand, the superblocks 200 without the cold data b22 are more likely to be selected as the target of the garbage collection. Therefore, by consolidating cold data b22, it can be expected that the valid data ratio of the other superblocks 200 without the cold data b22 will be lowered and thus the efficiency of the garbage collection will be improved.

Therefore, in the memory system 1 of an embodiment, the garbage collection control unit 112 has a mode (referred to as a second mode) for executing garbage collection for the purpose of consolidating the cold data b22 into fewer blocks in addition to a mode (referred to as a first mode) for selecting a superblock 200 based on the small amount of the valid data b2 therein and executing the garbage collection on this basis. The garbage collection in the second mode of the garbage collection control unit 112 will be described.

The garbage collection control unit 112 may periodically execute the garbage collection in the second mode at predetermined intervals (such as every day) and/or may execute the garbage collection in the second mode according to a command from the host 2 or a storage state or the like of the data of the superblocks 200.

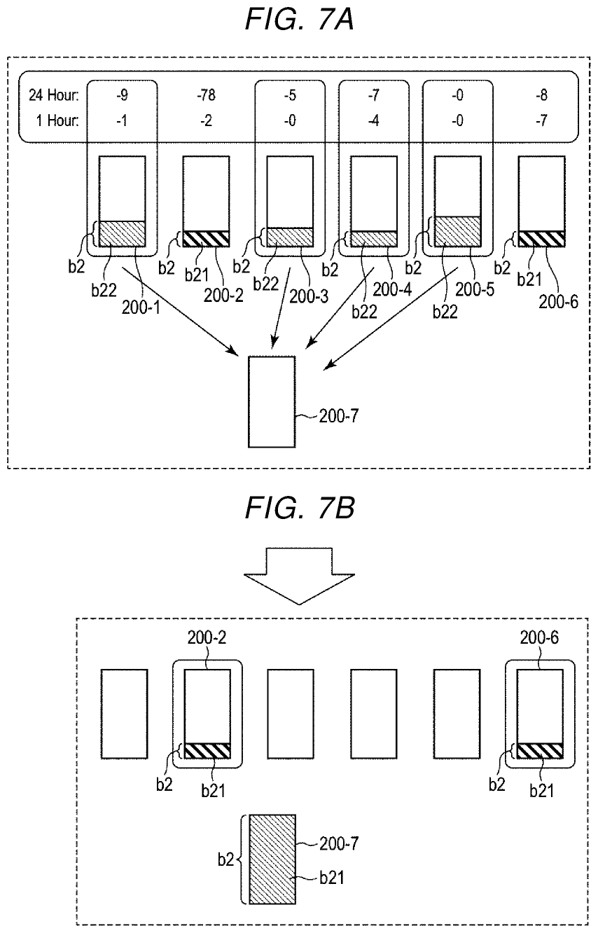

FIGS. 7A and 7B are diagrams illustrating the garbage collection in the second mode of the garbage collection control unit 112.

The block management unit 111 records, for example, the number of pages 123 for which data has been invalidated in the latest one hour period in the superblocks 200 in the used state as one item of the block information. The block management unit 111 stores the number of pages 123 invalidated (or the amount of invalidated data) over each one hour period over the course of a longer period of time, for example, one day (24 hours). Thus, twenty-four numbers are stored over the course of a day. By summing the 24 numbers, it is possible to calculate a daily total number of invalidated pages 123 (amount of invalidated data). In general, any period of time can be used in this context, for example, a three hour long period or a six hour long period can be used. It is noted that the block management unit 111 may independently record amount of invalidated data in each one hour period and amount of invalidated data for a one day long period.

When the garbage collection control unit 112 executes the garbage collection in the second mode, the garbage collection control unit 112 refers to the block information managed by the block management unit 111. The garbage collection control unit 112 detects the superblocks 200 in which the valid data b2 is estimated to be cold data b22 based on the valid data reduction number (number of invalidated pages 123) and selects these detected superblocks 200 as movement source blocks. That is, the garbage collection control unit 112 pays attention to the characteristic of the cold data b22 that is less likely to be converted into the invalid data, and selects the superblocks 200 in which the reduction frequency of the valid data b2 is small. In this context, the reduction frequency is the number/amount of data invalidated within a certain period of time.

The detection criterion of the superblock 200 by which the valid data b2 is estimated to be cold data b22, also pays attention to locality of the data. It is considered that, since the data existing in the same block are highly likely to be written at the same timing, when certain data in certain superblock 200 is not rewritten, the other data in the superblock 200 is also highly likely not to be rewritten.

The garbage collection control unit 112 may use a numerical value for a period of time of either the latest one hour or the latest one day as the reduction frequency of the valid data b2. However, in the memory system 1 of the present embodiment, numerical values for periods of time of both the most recent hour and day may be used. The garbage collection control unit 112 may use three or more periods of time. The garbage collection control unit 112 selects a superblock 200 as a movement source block by giving priority to short period of time rather than the long period of time.

FIG. 7A illustrates six different superblocks 200 (200-1 to 200-6) that are candidates for a movement source block. The superblock 200-7 (extracted from the free block pool a1) is illustrated as a movement destination block. In the numbers associated with each of the superblocks 200-1 to 200-6 represent the invalidated data amounts (numbers) in the most recent one day period and the most recent one hour period. The numbers are presented as negative numbers to indicate a reduction in valid data.

The garbage collection control unit 112 selects a superblock 200 for which the value obtained by adding the latest one day number and the latest one hour number is equal to or less than a threshold value as a movement source block. That is, in this example, the latest one hour number is double-counted (since it is in the 24 hour number as well). When there are a plurality of the superblocks 200 having similar one day numbers, the superblocks 200 for which the latest one hour number is relatively small is more likely to be selected as a movement source block. That is, the garbage collection control unit 112 uses the numbers from a plurality of periods of time but the shorter period of time is weighted more significantly than the longer period of time. The movement target superblock 200 is a superblock 200 for which the valid data b2 therein is estimated to be cold data b22.

The garbage collection control unit 112 may further set a coefficient for the latest one day and latest one hour numbers. That is, weighting using the coefficients may be performed so that the short period of time factors more in the determination of the target superblock 200 than does the long period of time.

Specifically, latest one day number can be multiplied by a first coefficient, and the latest one hour number can be multiplied by a second coefficient. In this example, by fixing the first coefficient to 1 and setting the second coefficient to a positive value, it is possible to adjust the weighting of the shorter period of time relative to the longer period.

In the example illustrated in FIG. 7A, in the superblock 200-6 one day number (24 hour) is 8 and this is smaller in magnitude than the latest one day of the superblock 200-1, which is 9. However, the latest one hour of the superblock 200-6 is 7 and the latest one hour of the superblock 200-1 is 1. The sum of latest one day number and the latest one hour number is 15 for the superblock 200-6 and 10 for the superblock 200-1. As a result, it is more likely that the superblock 200-1 will be selected as the movement source block than superblock 200-6. When the threshold value is set to be 13, the garbage collection control unit 112 selects the superblocks 200-1, 200-3, 200-4, and 200-5 as movement source blocks.

FIG. 7B illustrates a state after the garbage collection in the second mode. The cold data b22 originally stored in the superblocks 200-1, 200-3, 200-4, and 200-5 is collected in the superblock 200-7, which is the movement destination block. By consolidating the cold data b22 in one place (a single block in this example), it is possible to prevent the cold data b22 from being moved again in a garbage collection in the first mode.

The hot data b21 of the superblocks 200-2 and 200-6, which were not selected as the movement source blocks can be expected to be invalidated in the relatively near future. That is, the amount of data to be copied in the garbage collection can be reduced, and the Write Amplification Factor (WAF) of the memory system 1 can be reduced.

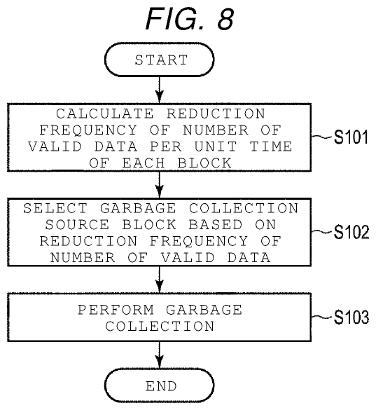

FIG. 8 is a flowchart illustrating a procedure of garbage collection in the second mode in the memory system 1 of the embodiment.

The garbage collection control unit 112 calculates the reduction frequency for the number of valid data per unit time of each block (S101). There are provided in this example two unit times, a short period of time and a long period of time, such as one hour and one day. A single unit time may be used or three or more unit times (time periods) can be used.

The garbage collection control unit 112 selects the garbage collection source block based on the reduction frequency of the number of valid data (S102). In the second mode, the garbage collection control unit 112 estimates that the block(s) for which the reduction frequency is small is a block occupied by cold data and selects such a block (or blocks) as a garbage collection source block.

Then, the garbage collection control unit 112 executes a garbage collection for the purpose of collecting the cold data in a single block (S103).

In detecting a superblock 200 estimated to be occupied by the cold data b22, the garbage collection control unit 112 may use other information in addition to the reduction number for valid data b2 (invalidated data number).

For example, the block management unit 111 can manage attribute information indicating whether the superblock 200 stores write data for a write process in accordance with a write command from the host 2 or stores write data for the garbage collection operation. The block management unit 111 may supply a candidate superblock 200 to the garbage collection control unit 112 based on the attribute information.

As described above, the detection criterion of the superblocks 200 occupied by the cold data b22 pays attention to the locality of the data. For this reason, the locality of the data becomes small in the movement destination block of the garbage collection in which the valid data b2 are collected from the plurality of superblocks 200. Therefore, the garbage collection control unit 112 may perform weighting based on the attribute information included in the block information managed by the block management unit 111.

In performing the weighting of valid data b2 for reduction numbers in the superblocks 200 in which the write data in accordance with a write command from the host 2 are stored, the garbage collection control unit 112 may apply a method of contrast correction as found in image processing.

Such a contrast correction expands or flattens a histogram that collects color data (0 [black] to 255 [white]) of each pixel, and for example, the contrast correction performs redistributing of the color data to the 255 (white) side for a dark image (an image with many values near 0) to improve visibility of the image.

Similarly to a contrast correction, the idea that larger ones are even larger than the average value of change, while smaller ones are even smaller than the average value of change may be used.

The garbage collection control unit 112 may use the amount of valid data b2 in each superblock 200 to select the movement source block during the garbage collection in the second mode. The amount of valid data b2 may also be included in the block information managed by the block management unit 111.

Among superblocks 200 in which the reduction frequency is small and the valid data b2 is estimated to be cold data b22, the superblock 200 having a large number of the valid data b2 may be highly likely to be a superblock 200 into which cold data b22 has already been collected. Therefore, the garbage collection control unit 112 may exclude such a superblock 200 from the candidates for the movement source block.

Alternatively, the garbage collection control unit 112 may define, for example, a function for evaluating appropriateness of each superblock 200 as a movement source block. This function may include two factors, a reduction frequency of the valid data b2 and an amount of the valid data b2, as variables.

As described above, the memory system 1 of an embodiment performs garbage collection in a second mode in which the cold data are consolidated. Accordingly, the memory system 1 can improve efficiency of the garbage collection in a first mode.

It is noted that the garbage collection in the second mode for the purpose of collecting the cold data in a single block is not limited to execution under the direction of the controller 11 of the memory system 1, but can also be executed at the direction of the host 2.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system, comprising:
a non-volatile memory having a plurality of blocks including first blocks including valid data and second blocks without valid data; and
a controller configured to execute a garbage collection process of moving valid data of first blocks to second blocks, the number of second blocks being fewer than the number of the first blocks to generate one or more free blocks, wherein,
the controller is configured to select the first blocks for the garbage collection process based on a reduction frequency of valid data in blocks in the plurality of blocks.

2. The memory system according to claim 1, wherein the controller is further configured to calculate a first reduction amount for valid data in a block over a first period of time as the reduction frequency for the block.

3. The memory system according to claim 2, wherein the controller is further configured to select blocks from the plurality of blocks having a low reduction frequency as the first blocks for the garbage collection process.

4. The memory system according to claim 2, wherein the controller is further configured to calculate a second reduction amount for valid data in a block in the plurality of blocks over a second period of time that is shorter than the first period of time.

5. The memory system according to claim 4, wherein the controller is further configured to select, as the first blocks, blocks in the plurality of blocks for which the sum of the first reduction amount and the second reduction amount is less than a threshold value.

6. The memory system according to claim 4, wherein the controller is further configured to select, as the first blocks, blocks in the plurality of blocks for which the sum of the first reduction amount multiplied by a first coefficient and the second reduction amount multiplied by a second coefficient is less than a threshold value.

7. The memory system according to claim 1, wherein the controller is configured to manage attribute information for the plurality of blocks, the attribute information indicating whether a block in the plurality of blocks stores write data related to performance of a command from a host device.

8. The memory system according to claim 7, wherein the controller is configured to exclude, based on the attribute information, the block in the plurality of block storing write data related to performance of a command from the host device from the first blocks for the garbage collection process.

9. The memory system according to claim 1, wherein
the controller is further configured to communicate with a host,
the controller is further configured to:
manage attribute information indicating whether a block in the plurality of blocks stores write data in accordance with a write command from the host or write data related to the garbage collection process,
calculate at least one of a first average value for the reduction in valid data in each of the plurality of blocks during a first period of time or a second average value for the reduction in valid data in each of the plurality of blocks during in a second period of time.

10. The memory system according to claim 1, wherein the controller is configured to exclude blocks in the plurality of blocks for which the stored amount of valid data is equal to or greater than a threshold value from the first blocks.

11. The memory system according to claim 1, wherein the controller is further configured to select the first blocks based on an amount of valid data in each block.

12. A method of controlling a non-volatile memory that has a plurality of blocks, the method comprising:
executing a garbage collection process of moving valid data of first blocks in the plurality of blocks to second blocks in the plurality of blocks, the number of second blocks being fewer than the number of the first blocks to generate one or more free blocks, wherein
the first blocks are selected for the garbage collection process from the plurality of blocks based on a reduction frequency of valid data in blocks in the plurality of blocks.

13. The method according to claim 12, further comprising:
calculating a first reduction amount for valid data in a block over a first period of time as the reduction frequency of the block.

14. The method according to claim 13, further comprising:
selecting blocks from the plurality of blocks having a low reduction frequency as the first blocks for the garbage collection process.

15. The method according to claim 13, further comprising:
calculating a second reduction amount for valid data in a block in the plurality of blocks over a second period of time that is shorter than the first period of time.

16. The method according to claim 15, further comprising:
selecting, as the first blocks, blocks in the plurality of blocks for which the sum of the first reduction amount and the second reduction amount is less than a threshold value.

17. The method according to claim 15, further comprising:
selecting, as the first blocks, blocks in the plurality of blocks for which the sum of the first reduction amount multiplied by a first coefficient and the second reduction amount multiplied by a second coefficient is less than a threshold value.

18. The method according to claim 12, further comprising:
storing attribute information indicating whether a block in the plurality of blocks stores write data in accordance with a write command from a host or write data related to the garbage collection process.

19. The method according to claim 12, further comprising:
excluding blocks in the plurality of blocks for which the stored amount of valid data is equal to or greater than a threshold value from the first blocks.

20. The method according to claim 12, wherein the first blocks are selected in consideration of an amount of valid data in each block.
